(19) United States
(12) Patent Application Publication
(10) Pub. No.: US 2025/0256952 A1
(43) Pub. Date: Aug. 14, 2025

(54) Beverage Dispenser and Method for Beverage Dispensing

(71) Applicant: Heineken Supply Chain B.V., Amsterdam (NL)

(72) Inventors: Eric Richard Brouwer, Amsterdam (NL); Bart Jan Bax, Amsterdam (NL); Jeroen Frank Otto, Amsterdam (NL); Arie Maarten Paauwe, Amsterdam (NL)

(21) Appl. No.: 18/857,253

(22) PCT Filed: Apr. 19, 2023
(86) PCT No.: PCT/NL2023/050205

§ 371 Date: Oct. 16, 2024

(30) Foreign Application Priority Data
Apr. 19, 2022 (EP) 22168871.6

(51) Int. Cl. B67D 1/08; B67D 1/00; B67D 1/12

(52) U.S. Cl. CPC B67D 1/0894; B67D 1/0016; B67D 1/0047; B67D 1/0079; B67D 1/0081; B67D 1/0801; B67D 1/008; B67D 2001/009; B67D 2001/0812; B67D 1/124

(57) ABSTRACT

A beverage dispenser is provided, comprising a housing, wherein the dispenser is connected to or connectable to a beverage source and/or comprises and/or is connectable to at least one fluid source and at least one source for a beverage ingredient, and comprises a mixing system for mixing into a beverage fluid from the at least one fluid source and the at least one beverage ingredient from the beverage ingredient source, wherein the dispenser further comprising a dispensing system for dispensing the beverage, the dispensing system comprising at least a spout with an outlet end, wherein the beverage dispenser further comprises at least one positioning element for positioning a rim of a drinking container relative to the outlet end of the spout.

This disclosure relates to a beverage dispenser. The disclosure further relates to a method for dispensing a beverage. Furthermore the disclosure relates to a cartridge for use in a post-mix beverage dispenser.

Beverage dispensers are known in the art, for example for dispensing beer, soft drinks or coffee or thee. Beverage dispensers are known for dispensing beverages supplied ready for dispensing. Beverage dispensers are also known for dispensing post-mix beverages. It is known to provide a beverage ingredient, such as coffee, thee or beverage concentrate in a cartridge which can be inserted into a beverage dispenser, where after a fluid, such as water, is passed along or through the cartridge extracting the beverage ingredient or at least parts of said beverage ingredient from the container, mixing it with said fluid for forming a beverage.

Beverage dispensers are known in which a drinking container such as a glass or cup is placed in the dispenser, below a spout, resting on a bottom of said container, where after a start button is pushed for starting the process of dispensing the beverage.

In other beverage dispensers a drinking container is held by a person during dispensing, wherein the drinking container is pushed substantially horizontally against a lever. By pushing the lever with the drinking container dispensing of beverage into the drinking container is obtained.

When dispensing carbonated beverages, especially beverages in which a foam head is desirable when dispensing into a drinking container, such beverage dispensers may be disadvantageous, because the method of dispensing may lead to excessive foaming or not enough foaming, depending on the type of drinking container used and the position thereof relative to the dispensing spout.

An aim of the present disclosure is to provide for an alternative beverage dispenser. An aim is to provide a beverage dispenser with which the position of the drinking vessel during dispensing of beverage is predefined, such that dispensing can be optimized, even for people who are not or little trained in dispensing such beverages. An aim of the present disclosure is to provide for a dispenser and method with which the position of the drinking vessel during dispensing of beverage is predefined, such that dispensing can be optimized, even when using different types of drinking containers. An aim of the present disclosure is to provide for a beverage dispenser with which a carbonated beverage can be dispensed with a desired foam head. An aim of the present disclosure is to provide for an alternative method for dispensing a beverage, such as for example a post-mix beverage. An aim of the disclosure is to provide a method with which a beverage can be dispensed with a proper head of foam.

At least one of these aims is at least in part obtained by a dispenser or method according to the disclosure.

A beverage dispenser of the disclosure comprises a housing wherein the dispenser either is connected to or connectable to a beverage source or the dispenser comprises and/or is connectable to at least one fluid source and at least one source for a beverage ingredient and comprises a mixing system for mixing into a beverage fluid from the at least one fluid source and the at least one beverage ingredient from the beverage ingredient source, or both. In other words the dispenser can be a dispenser for dispensing beverages delivered to the dispenser prepared, ready for dispensing, or can be a post-mix beverage dispenser or a combination thereof.

The dispenser further comprises a dispensing system for dispensing the beverage, the dispensing system comprising at least a spout with an outlet end. According to the disclosure the beverage dispenser further comprises at least one positioning element for positioning a rim of a drinking container relative to the outlet end of the spout.

Defining the position of the rim relative to the outlet end of the spout has the advantage that the dispensing can be controlled more accurately, especially the flow of beverage dispensed relative to the drinking container.

Preferably at least two positioning elements are provided, spaced apart from each other, such that the position of the rim of a drinking container during use can even better be defined and controlled.

In advantageous embodiments of the dispenser the spout has a longitudinal axis, at least at the outlet end, and an axial dispensing direction along said longitudinal axis. In such embodiments preferably the or each positioning element is positioned such that of a rim engaging said at least one positioning element a plane defined by said rim is at an angle relative to said longitudinal axis of the spout, such that the dispensing direction is directed to an inner surface area of the drinking container adjacent the rim.

The or each positioning element can be designed for extending over at least part of an opening of a drinking container defined by said rim. This allows for easy positioning of different drinking containers against the positioning element or elements. Even if only a single such positioning element is provided the position of the rim can be defined since the rim will be curved providing for at least three contact points between the rim and such positioning element.

It can be advantageous when the at least one positioning element has a substantially flat or stepped engaging surface for engaging the rim of said drinking container. The one positioning element or at least one of the positioning elements can be provided with a guide element extending from said engaging surface for engaging an outer surface part of the drinking container, adjacent the rim. This will even more easily allow aligning the rim of a drinking container with the or each positioning element.

A dispenser according to the disclosure can be designed for dispensing ready to serve beverages, for example by connecting the dispenser to a container comprising a beverage, such as a keg or a bottle or the like. Alternatively or additionally the dispenser can be designed for dispensing post mix beverage, for example by mixing at least one beverage ingredient with at least one base liquid. The beverage ingredient can for example be provided from an ingredient container such as for example a cartridge, which may be received in the beverage dispenser. To that end the dispenser can be provided with a cartridge receiving space.

In a dispenser with a beverage ingredient cartridge, also referred to as or pod, capsule, or pouch or similar wording, or more generally as ingredient container, the spout or at least part thereof can be part of the cartridge. The spout can be provided such that it can be placed and removed with the cartridge. Preferably a beverage mixed with the beverage ingredient from the cartridge will exit the cartridge through the spout, without contacting the further dispenser. Thus a need for cleaning of the dispenser may be significantly reduced. In embodiments the cartridge can comprise a valve, for example for allowing a base liquid to enter the cartridge or for allowing the beverage ingredient and/or a base liquid mixed with said ingredient to leave the cartridge.

The dispenser can comprise at least a valve, wherein the dispensing system further comprises a valve actuation system for opening the at least one valve and dispensing the beverage into a drinking container. The valve actuation system further preferably comprises a drinking container detection system comprising at least said at least one positioning element, the drinking container detection system arranged for during use detecting a position of the drinking container, especially of a rim of the drinking container relative to at least one part of the beverage dispenser.

The drinking container detection system is preferably arranged for during use detecting the position of the drinking container relative to the outlet end of the spout, wherein the spout can be part of the valve actuation system.

In a dispensing system according to the disclosure the valve actuation system can comprise at least a first and a second positioning element, spaced apart from each other. In such embodiments at least one of the first and second positioning element is movable relative to the other of the first and second positioning element and/or the first and second positioning element are movable relative to the housing, wherein only when said one of the first and second positioning element is moved relative to the other of the first and second positioning element and/or the first and second positioning element are moved relative to said housing the at least one valve is opened for dispensing of said beverage.

In such embodiments the dispensing of the beverage is dependent on the position of the drinking container relative to at least one of and preferably at least two of said positioning elements, wherein movement of at least one and preferably at least two spaced apart positioning elements allows for the beverage to be dispensed.

In such embodiments the said first positioning element can have a first contact surface and the second positioning element a second contact surface, which first contact surface and second contact surface are in a plane inclined relative to a horizontal plane, such that a drinking container has to be tilted in order to be pushed against both the first and second contact surface simultaneously.

In a dispenser according to the disclosure, suitable at least for post mix dispensing of a beverage, during use the dispenser can comprise a mixing chamber for mixing at least one fluid with at least one beverage ingredient and/or for receiving beverage mixed from said at least one fluid and said at least one beverage ingredient, prior to dispensing of the beverage. The mixing chamber can be part of the beverage dispenser. The mixing chamber can alternatively be part of a cartridge. Alternatively a mixing chamber can be provided in both the dispenser and a cartridge and/or can be formed by cooperation of the dispenser and said at least one cartridge.

The mixing chamber can have a volume substantially equal to or larger than the volume of the drinking container. The volume of the mixing chamber or combined mixing chambers can for example be, but is not limited to, between 0,15 and 1 liter, such as for example between 0.2 and 0.5 liter. Alternatively the mixing chamber can be much larger, for example large enough to contain multiple servings. In such embodiments the mixing chamber or combined mixing chambers can for example have a volume of between 0.5 and 10 liters.

In embodiments the mixing chamber can be an expandable mixing chamber, which should be understood as a mixing chamber which in a first state has a smaller internal volume than in a second state, said internal volume suitable for containing a beverage mixed from at least a base liquid and a beverage ingredient.

The disclosure is further directed to a method for dispensing a beverage into a drinking container, wherein a beverage is supplied from a beverage source or is formed from at least a fluid and at least one beverage component, wherein the beverage is dispensed from a beverage dispenser. In a method according to the disclosure an open end, especially a rim, of a drinking container is held against at least one positioning element of the dispenser, wherein the positioning element or elements define a position of the drinking container relative to a dispensing spout of the dispenser.

With a method according to the disclosure a user is aided by the beverage dispenser, especially by the at least one positioning element, in holding the drinking container is a proper position for dispensing the beverage into the drinking container. This is especially, but not exclusively, important for dispensing beverages which are intended to form a foam layer or head on the beverage in the drinking container, such as for example beer.

In a method according to the disclosure preferably the at least one positioning element is part of a drinking container detection system, wherein if the drinking container is detected by the drinking container detection system of the dispenser beverage is or can be dispensed. Especially when a proper position of the drinking container is detected, preferably at least at the beginning of a dispensing cycle for the beverage.

In a method according to the disclosure at least a first positioning element and a second positioning element can be used, wherein the first positioning element comprises at least a first positioning surface and the second positioning element comprises at least a second surface, wherein when said drinking container is pushed against said first positioning and against said second positioning surface a valve actuation mechanism of the beverage dispenser is activated and beverage is dispensed into said drinking container. In embodiments movement of at least one of the positioning elements by the container can result in dispensing of beverage or at least in allowing beverage to be dispensed.

In a method according to the disclosure the dispenser can comprise at least a detector for detecting an inner wall surface of the drinking container, wherein when the said surface of the drinking container is pushed against the detector beverage is or can be dispensed.

The disclosure is further directed to a cartridge containing a beverage component for use in a beverage dispenser, wherein the cartridge preferably comprises at least an inlet for a fluid for mixing with the beverage component and a spout for dispensing the beverage formed from the fluid and the beverage component. Alternatively the cartridge can be designed for allowing the beverage component to be dispensed from the cartridge into a fluid stream, for example by pressurizing the cartridge, by suction, by using venturi effect obtained by the fluid stream or any other suitable manner. A cartridge for use in a system or method according to the disclosure can also be designed without a spout, as known in the art. Throughout the disclosure, a beverage component can also be referred to as beverage ingredient, beverage concentrate or the like.

When the beverage component is a beverage concentrate, the beverage concentrate may be based on a fermented beverage, such as a beer, wine or a cider. The beverage concentrate may as such comprise a liquid such as water with particles mixed, suspended and/or dispersed therein. The beverage concentrate may hence be an aqueous liquid.

As options, the beverage component may be essentially free of ethanol or comprise a particular concentration of ethanol, such as 25% or less, 10% or less, 5% or less, or even 1% or less by volume. As a further option, the beverage concentrate may comprise dissolved carbon dioxide and/or any other gas such as nitrogen.

In examples, the beverage concentrate may comprise or consist of solid particles. As such, the beverage concentrate may for example be a powder or a tablet. The solid beverage concentrate can be dissolved, suspended, or dispersed into one or more base liquids. Multiple beverage concentrates may be used to form the post-mixed beverage, which multiple beverage concentrates may be in liquid and/or solid form. The one or more base liquids may for example be water, carbonated water, ethanol, ethanol dissolved in water, and/or any combination thereof. In particular when one or more base liquids are mixed with the beverage concentrate inside the cartridge, the beverage concentrate may comprise or consist of solid particles which can be dissolved into the one or more base liquids.

A beverage concentrate based on a fermented beverage may be obtained by concentrating a fermented beverage, and/or by brewing a fermented beverage with a high concentration of flavouring agents. The high concentration of flavouring agents may be higher than a typical concentration of flavouring agents for said fermented beverage. For example, when the beverage concentrate comprises four times the flavouring agents per volume compared to a conventional beverage, the concentrate has to be diluted four times to obtain the desired concentration of flavouring agents.

The high concentration of flavouring agents may result in a high dry matter content in the beverage concentrate, which is higher than a typical dry matter content in a conventional beverage. The high concentration of flavouring agents may be obtained by brewing the fermented beverage with a higher concentration of raw materials such as cereal grains, for example malted barley, wheat, or maize, and/or hops compared to the concentration of raw materials used for brewing a conventional beverage which is typically not mixed with a base liquid before consumption.

The beverage concentrate may in general comprise one or more flavouring agents, for example aimed to mimic the flavour of another beverage. In particular, flavouring agents may be used to mimic the flavour of a fermented beverage, such as a beer, wine, or a cider. A flavouring agent may for example be an aromatic compound, an ester or an alcohol. By mixing one or more flavouring agents, in particular into an aqueous solution, a beverage concentrate may hence be obtained. It will thus be understood that a beverage concentrate may also be formed without a brewing or fermenting process.

It will be understood that the cartridge may be a single-serving disposable cartridge. Single-serving implies that a single quantity of post-mixed beverage can be dispensed using the cartridge, preferably in one continuous dispensing action. The single quantity may correspond to amount of beverage concentrate required to obtain a typical filling volume of a beverage container such as a glass, which quantity may for example be 200 mL, 250 mL, 300 mL, 500 mL, or 568 mL (i.e. 1 pint), when the beverage concentrate is mixed with a volume of base liquid.

The cartridge may further be a single-use cartridge, i.e. not arranged to be refilled with beverage concentrate after being used to dispense beverage concentrate from the cartridge. Preferably, the cartridge comprises recyclable materials.

Alternatively, the cartridge may be a multiple serving disposable cartridge. From a multiple serving disposable cartridge, a plurality of discrete volumes of beverage concentrate can be dispensed.

A cartridge according to the disclosure can comprise a chamber for containing a beverage prior to dispensing, which chamber may be a mixing chamber. The chamber can be an expandable chamber. For example the chamber can be designed such that it can hold at least a single serving of beverage.

For a better understanding of the disclosure different embodiments of a dispenser, method a cartridge will be discussed, with reference to the drawings, which are shown by way of example only and should not be considered as limiting the scope of the disclosure. Therein shows schematically:

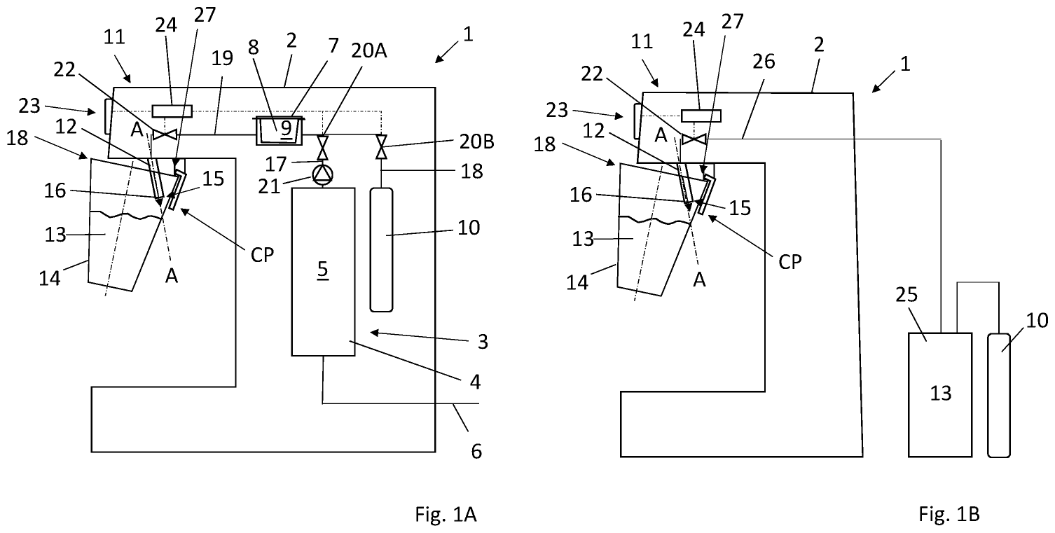

FIGS. 1A and 1B two types of beverage dispenser, for post-mix dispensing and for dispensing from a beverage container respectively;

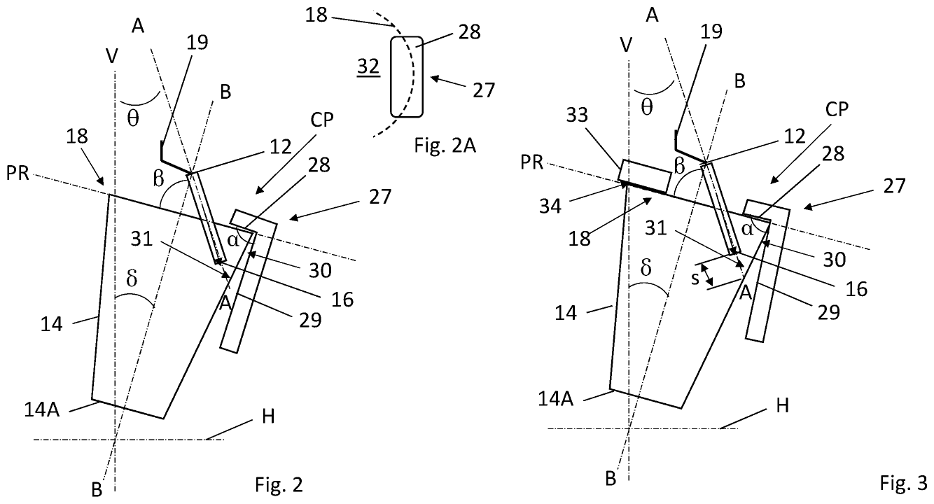

FIG. 2 a first embodiment of part of a beverage dispenser, showing a spout and positioning element, and a beverage drinking container;

FIG. 2A showing part of a rim engaging a positioning surface;

FIG. 3 a second embodiment of part of a beverage dispenser, showing a spout and two positioning elements, and a beverage drinking container;

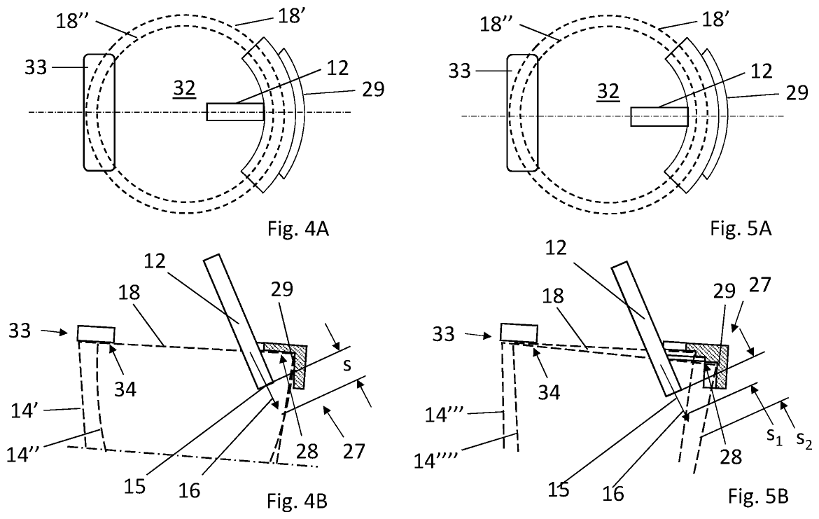

FIGS. 4A and 4B in top view and partly in side view positioning elements of a beverage dispenser, for example according to FIG. 3, with different shapes of upper portions of drinking containers;

FIGS. 5A and B in top view and partly in side view positioning elements of a beverage dispenser, for example according to FIG. 3, with a positioning element with a stepped surface and different sizes of upper portions of drinking containers;

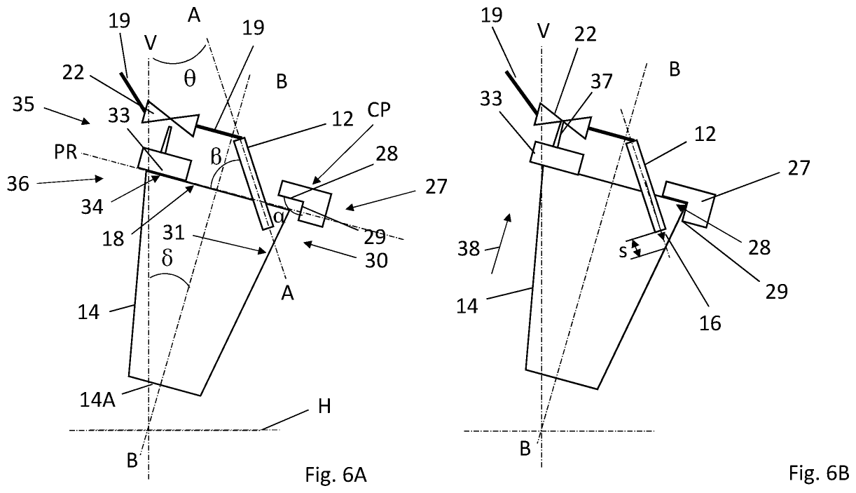

FIGS. 6A and B in side view a further embodiment of part of a beverage dispenser according to the disclosure, with a valve actuation system, in rest position and in active position respectively;

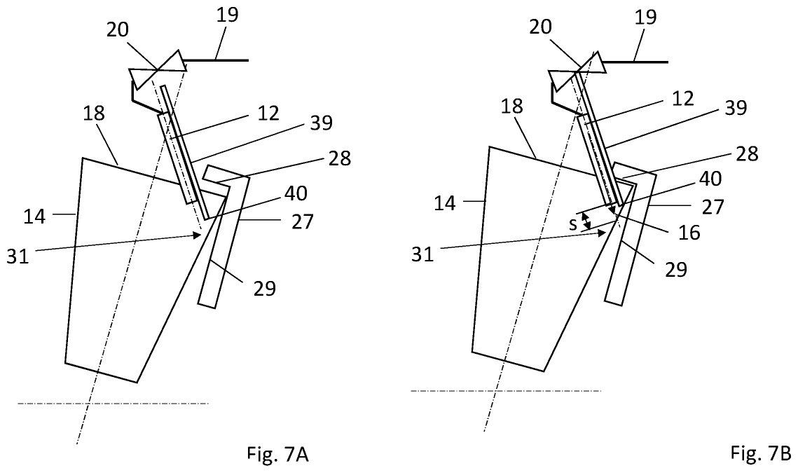

FIGS. 7A and B in side view a further embodiment of part of a beverage dispenser according to the disclosure, with an alternative valve actuation system, in rest position and in active position respectively;

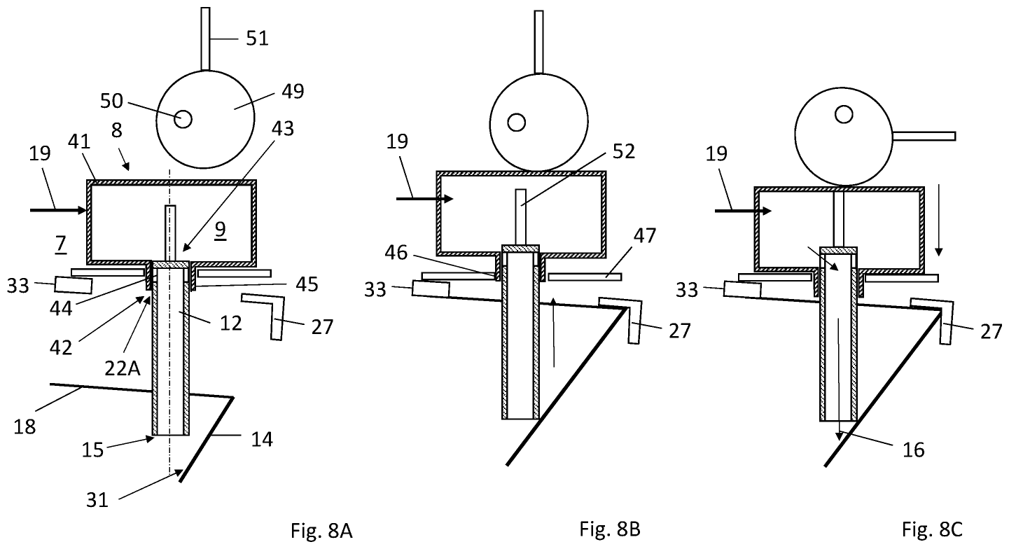

FIG. 8A-C part of a further alternative embodiment of a beverage dispenser according to the disclosure, for post mix dispensing, showing a cartridge with a spout and an activation mechanism;

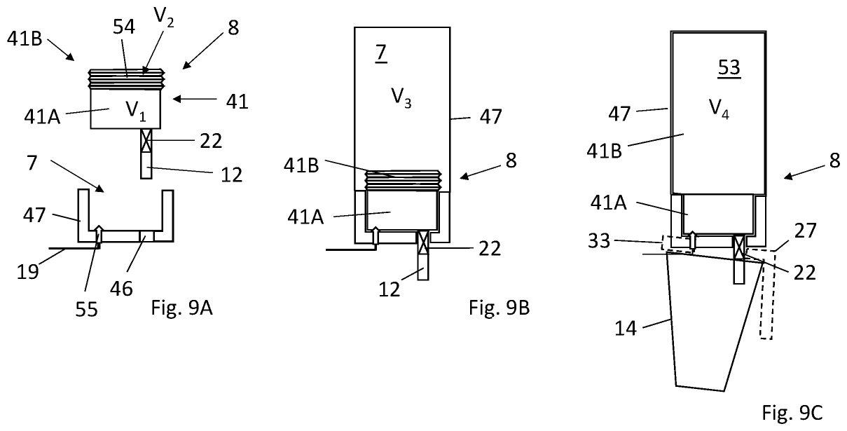

FIG. 9A-C part of a further alternative embodiment of a beverage dispenser according to the disclosure, for post mix dispensing, showing a cartridge with a spout and an expandable mixing chamber; and

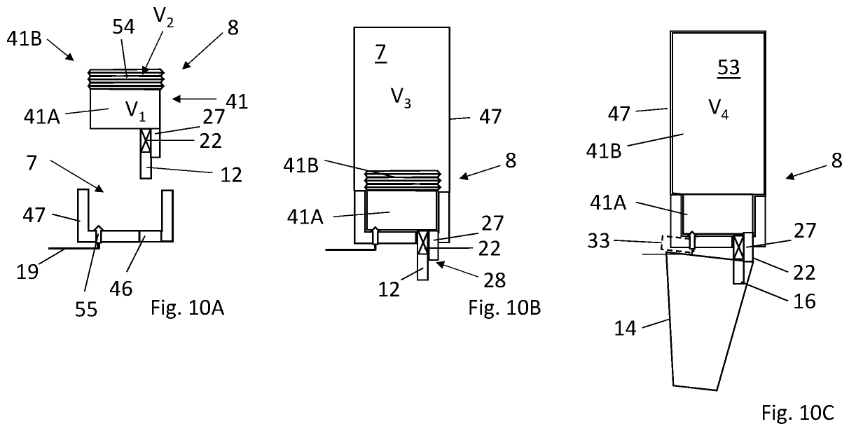

FIG. 10A-C part of an even further alternative embodiment of a beverage dispenser according to the disclosure, for post mix dispensing, showing a cartridge with a spout, a positioning element, and an expandable mixing chamber.

In the figures identical or corresponding parts are represented with the same or corresponding reference numerals. The drawings are only schematic representations of embodiments of the invention or parts thereof, which are given by manner of non-limiting examples.

In FIG. 1A a beverage dispenser 1 is schematically shown, suitable for at least post mix dispensing. The dispenser 1 comprises a housing 2 in which by way of example in this embodiment a fluid source 3 is provided, shown here as a fluid chamber 4 for containing a base liquid 5, for example water of a base beverage such as beer, lemonade, wine, cider or the like. In embodiments the fluid chamber 4 can be an exchangeable chamber, such as a container, which can be refilled outside the housing, or can be exchanged for a different container. In embodiments the fluid chamber 4 can be connected by an inlet line 6 to a source of base liquid outside the housing 2, for example a water mains. Cooling means such as an inline cooler or a contact cooling (not shown) can be provided for cooling the base liquid 5. In embodiments multiple chambers 4 can be provided, for containing base liquids, for example different base liquids to choose from or to be combined when preparing a beverage. Cooling means can further be provided for cooling the cartridge 8, or more in general for cooling the cartridge chamber 7.

The housing 2 in FIG. 1A further comprises at least one cartridge chamber 7 in which a cartridge 8 can be placed, containing a beverage ingredient 9 such as a beverage concentrate. The cartridge 8 can also be referred to as pod, capsule, container, pouch, ampule, or the like.

Furthermore the dispenser 1 comprises a gas container 10, for supplying gas under pressure, for example CO2 or N2 or another gas or gas mixture, to be mixed with the at least one base liquid 5 and at least one beverage ingredient 9 for forming a gaseous beverage, further in general also referred to as carbonated beverage.

The dispenser 1 further comprises a dispensing system 11 for dispensing the beverage formed, comprising at least a spout 12 for dispensing the beverage 13 mixed in the beverage dispenser 1 into a beverage container 14, such as for example a glass, cup, beaker, jug or the like. The spout 12 has an outlet end 15 through which the beverage 13 can exit the spout 12. At least at said end 15 the spout has a longitudinal axis A-A, such that the beverage 13 can be dispensed substantially in said axial direction A-A, as indicated by the arrow 16.

A first line or conduit 17 extends from the fluid chamber 4 to the ingredient chamber 7. A second line or conduit 18 extends from the gas container 10 to the ingredient chamber 7. The first and second lines 17, 18 may be separate or may be partly the same, as shown in FIG. 1A. from the ingredient chamber 7 a third line 19 extends, to the spout 12. Inside the ingredient chamber the at least one ingredient 9, the at least one base liquid 5 and the at least one gas from the gas container 10 is brought together, for forming the beverage 13 in said chamber and/or in the third line 19, for dispensing by the dispensing system 11. Further mixing provisions can be provided (not shown) for mixing the fluid(s), ingredient(s) and gas(ses), such as for example a mechanical mixer, a mixing chamber, jets and/or jet chambers and the like (not shown). In the first line 17 and/or in the second line 18 a valve 20 can be provided. In FIG. 1A there are two such valves 20A, 20B shown, for blocking and allowing passage of fluid and gas flowing into the lines 17, 18. Obviously one or both of these valves can be omitted. Furthermore a pump 21 is provided in the first line 17, for pressurizing the base liquid 5. It shall be clear that the or each base liquid can also be pressurized in a different manner, for example by squeezing the liquid chamber 4, by external pressure source, by feeding gas, for example gas from the gas container 10 into the base liquid in the chamber 4 or similar methods known in the art. Obviously in embodiments the gas container 10 can be omitted or closed off during post mixing pf a beverage, is no such gas is needed or desired in such beverage.

In the embodiment of FIG. 1A furthermore the dispenser 1 comprises a dispense valve 22, which in this embodiment is part of the dispensing system. At least the dispense valve 22 and a control panel 23 are connected to a control unit 24 in the beverage dispenser 1, for controlling the dispense valve 22 in order to dispense a serving of beverage 13. In embodiments the valves 20A, 20B and/or the pump 21 can also be connected to the control unit 24.

In the ingredient chamber 7 the beverage ingredient(s) 9 can be discharged from the container(s) 8 into the base liquid(s) in any suitable manner. For example the base liquid(s) and gas(ses) can be introduced into the cartridge 8, mixing with the beverage ingredient(s) 9 forming the beverage 13 inside and/or after exiting the cartridge 8 again. In embodiments the cartridge can be compressed for squeezing the beverage ingredient(s) from the cartridge into the mixture of base liquid(s) and gas(ses) passing from the first/second line 17, 18 to the third line 19. In embodiments the beverage ingredient(s) can be discharged by creating a pressure difference between the cartridge(s) and the ingredient chamber 7 and/or the lines 17, 18 and/or 19, for example creating a venturi effect. The beverage ingredient 9 can have any suitable consistency, for example powder, liquid, pellets, freeze dried, suspension and the like, or combinations thereof. In embodiments the beverage ingredient or at least a beverage ingredient 9 is or comprises a beverage concentrate or beverage syrup, or an alcohol, or combinations thereof.

In embodiments the liquid chamber 4 can be sized for containing base liquid for a single serving of beverage 13, for example between 0.2 and 1 liter, for example between 0.2 and 0.5 liter, such as for example between 0.2 and 0,3 liter. In embodiments the liquid chamber can be designed for containing base liquid for multiple servings, for example between 1 and 20 liters, such as for example between 1 and 10 liters.

In embodiments a beverage chamber can be provided between the ingredient chamber 7 and the dispense valve 22, sized for containing a volume of beverage 13 prior to serving. The volume of such beverage chamber (not shown) can for example be designed for containing a single serving or a limited number of servings of beverage 13, for example between 0.2 and 0.5 liter, or for multiple servings, for example between 1 and 20 liters, such as for example between 1 and 10 liters, such as for example between 1 and 8 liters. In embodiments such beverage chamber can be designed for containing only a small volume of beverage, for example between 0.1 and 0.2 liter, smaller than the volume of a single serving as expected, for buffering part of a beverage. By providing a beverage chamber the serving of beverage 13 can be mixed substantially prior to dispensing.

FIG. 1B shows schematically a beverage dispenser 1 similar to that of FIG. 1A, wherein however the liquid chamber 4 and gas container 10 have been removed from the beverage dispenser housing 2. This dispenser 1 is designed for dispensing ready mixed or pre-mixed beverages 13 from a beverage container 25. The dispenser 1 can further be used for dispensing conventionally brewed beverages, such as beer and cider. In the embodiment shown the beverage container 25 is positioned outside the dispenser 1, connected to the dispensing valve 22 by a beverage line 26. A gas container 10 is also placed outside the dispenser housing 2, and is connected to the beverage container 25 in a known manner. In alternative embodiments the beverage 13 in the beverage container 25 can be pressurized differently, for example by packaging the beverage 13 in an inner container of a Bag-in-Container (BIC) or Bag-in-Box or -Bottle (BIB) and compressing said inner container, as for example known from the Heineken® Blade® system, or in any other suitable way.

It will be understood that the dispensers 1 as shown in FIGS. 1A and 1B are only shown by way of example.

In a dispenser according to the disclosure the dispenser 1 further comprises drinking container positioning provisions CP comprising at least one positioning element 27 for positioning a rim 28 of a drinking container 14 relative to the outlet end 16 of the spout 12. In FIG. 2-10C further embodiments of such drinking container positioning provisions CP shall be discussed, by way of example, which can each be combined with a beverage dispenser, such as for example shown in FIG. 1A and/or in FIG. 1B.

FIG. 2 shows a first embodiment of a drinking container positioning provision CP, basically as shown in FIGS. 1A and 1B. The provision CP comprises a first positioning element 27, which in this embodiment comprises an engaging surface 28 extending at an angle α relative to a guide surface 29 of the first positioning element, for example an angle between 45 and 135 degrees, such as for example between 60 and 120 degrees, such as for example about 90 degrees. The guiding surface 29, if provided for, extends, during use, from said engaging surface 28 along an outer surface part 30 of the drinking container 14, adjacent the rim 18.

According to the disclosure the positioning element 27 is positioned such that of a rim 18 engaging said positioning element 27 a plane PR defined by said rim 18 is at an angle β relative to said longitudinal axis of the spout 12. such that the dispensing direction 16 of the spout 12 is directed to an inner surface area 31 of the drinking container 14 adjacent the rim 18.

As can schematically be seen in FIG. 2A the engaging surface 28 of the first positioning element 27 during use extends partly over the open side 32 of the drinking container 14, defined by the rim 18. Thus at least three contact point, more specifically a curved line contact between the rim 18 and the surface 28 can be obtained, defining the position of the rim 18, and thus of the drinking container 14 relative to the positioning element 27 and thus relative to the spout 12. The guiding surface 29 can be used for guiding the rim 18 towards the engaging surface 28 and further defining the position of the rim relative to the engaging surface 28, even further defining the position of the drinking container 14 relative to the spout 12. Especially relative to the outlet end 15 of the spout 12.

Defining the position of the drinking container 14 relative to the outlet end 15 of the spout 12 and the axial direction near said end, hence the dispensing direction 16, provides for an easy way of controlling the dispensing of the beverage into the drinking container 14, and especially of controlling forming of foam when the beverage 13 is a carbonated beverage, such as beer. This is especially advantageous of the beverage is a beverage on which a layer of foam or a foam head is to be formed, such as beer.

In the embodiments shown and described a drinking container 14 is shown, having a longitudinal axis B-B extending centrally through the drinking container 14, perpendicular to the surface PR defined by the rim 18 and the bottom 14A. Preferably the drinking container positioning provisions CP are positioned such that if the rim 18 is engaged thereby, the longitudinal axis B-B extends at an angle δ relative to a vertical plane V (FIG. 2) which is preferably not 1800 or 0° and preferably is a sharp angle, such that the drinking container 14 is held in a tilted position relative to a straight up position. The angle δ can for example be between 3 and 60 degrees, such as for example between 5 and 45 degrees, such as for example between 10 and 30 degrees. In the embodiments shown the longitudinal axis A-A of the spout 12 extends at an angle θ relative to the vertical plane V. The said angle θ can for example be between 0 and 60 degrees, such as for example between 5 and 45 degrees, such as for example between 5 and 30 degrees. In embodiments the angle θ can be chosen such that during use the longitudinal axis A-A of the spout 12 at the outlet end 15 extends at the angle β relative to the plane PR defined by the rim 18. Any beverage dispensed from the outlet end will therefore have a dispensing direction 16 impacting on said inner surface part 31 of the drinking container 14 adjacent the rim 18 and thus the beverage 13 will flow along the inner surface 31 towards the bottom of the drinking container 14. Preferably the positioning element or elements CP is/or are provided such that when the rim 18 is pressed against it/them, the outlet end 15 of the spout 12 is at a distance s from the relevant inner surface part 31 of the drinking container 14, measure along the dispensing direction 16, which distance s preferably is between about 5 and 20 mm. Thus foaming of the beverage 13 can be controlled better than when the beverage is dispensed directly towards the bottom 14A or into a layer of beverage inside the drinking container 14 when the drinking container is not yet filled substantially, for example to a level halfway up the drinking container 14.

FIG. 3 schematically shows part of a beverage dispenser 1, similar to FIG. 2, but in this embodiment the positioning provision CP comprises a first positioning element 27, similar to that as shown in FIG. 2, and a second positioning element 34, spaced apart from the first positioning element 27. The second positioning element has a second engaging surface 34 facing the same way as the first engaging surface 28, such that the rim 18 of a drinking container 14 can engage both engaging surfaces 28, 34 simultaneously. In the embodiment shown the two engaging surfaces 28, 34 are provided such that they engage opposite portions of the rim 18 across the opening 32 defined by the rim 18. The spout 12 extends between said positioning elements 27, 33. Using two such positioning elements 27, 33 can further improve proper positioning of the drinking container 14.

In the embodiment shown in FIG. 3 the two positioning elements 27, 33 can be provided in fixed positions, such that the engaging surfaces 28, 34 are in the same plane, corresponding with the plane PR if the rim 18 is laced against both surfaces. One or all of the engaging elements 27, 33 can be made of a hard or of a resilient material, and/or can be connected to the housing 2 resiliently, such that they can accommodate when engaged by a rim 18, for example for repositioning slightly when engaged.

FIGS. 4A and 4B show in top view and cross sectional side view respectively positioning elements 27, 33 as for example shown in FIG. 3, with a spout 12 and in phantom lines the upper part of two different drinking containers 14′, 14″. As can especially be seen in FIG. 4B both engaging surfaces 28, 34 are substantially flat, and are dimensioned such that they can extend over a portion of the opening 32 of different sized drinking containers 14′, 14″, engaging the rim 18′, 18″ thereof.

The first positioning element 27 in this embodiment is curved, in the view of FIG. 4A, concave towards the spout 12, for example with a curvature resembling the curvature of the rim 18′ of the larger drinking container. Thus a drinking container 14 pushed against the positioning element 27 is guided towards a central position relative to the positioning element 27 too. Obviously the positioning element 27 can be shaped and dimensioned differently, for example straight.

In FIGS. 5A and B again in top view and in cross sectional side view respectively positioning elements 27, 33 as for example shown in FIG. 3, with a spout 12 and in phantom lines the upper part of two different drinking containers 14′″, 14″″. As can especially be seen in FIG. 5B the second engaging surface 34 can be flat, whereas the first engaging surface 28 can be stepped. This allows for adjusting the position of the drinking container 14 relative to the positioning provision in a few defined steps/positions. Such adjusting or choice in position of the drinking container 14 relative to the positioning provision can for example depend on the size of the drinking container 14 and/or the shape thereof.

As is shown in FIGS. 4B and 5B the drinking containers 14 which can be used in or with a system according to the disclosure can be shaped and dimensioned differently. For example the drinking container 14 can have a substantially truncated conical shape, as disclosed for drinking containers 14′, 14′″ and 14″″, or for example more bowl shaped, as shown for drinking container 14″. Because of the positioning provisions CP for the drinking containers 14 the dispensing direction 16 of the beverage relative to the inside wall part 31 of the container 14 and the distance between the outlet end 15 and the said inside wall part 31 is controlled within suitable values for proper dispensing of the beverage, especially a carbonated beverage such as beer, for example a lager beer or a pilsner, an API or the like beer dispensed with a foam head. Additionally or alternatively this can be used for avoiding excess foaming.

In FIG. 4B by way of example a distance s is shown, which is substantially the same for a drinking container 14′ with a truncated conical shape as for a more bowl or goblet shaped drinking container 14″. In FIG. 5B different distances s₁, s₂ are shown between the outlet end 15 and the inner surface 31, for differently sized drinking containers 14′″, 14″″, by way of example only, in which for example the distance s₁ is about 5 mm, and the distance s₂ is about 20 mm. These distances are shown by way of example only, and may be chosen differently.

In embodiments the dispensing system 11 comprises a valve 22, as for example disclosed in FIG. 1. In such embodiments the dispensing system 11 further comprises a valve actuation system 35 for opening the at least one valve 22 and dispensing the beverage 13 into the drinking container 14. The valve actuation system 35 comprises a drinking container detection system 36. The drinking container detection system 36 in this embodiment comprises at least at least one positioning element 27, 33 arranged for during use detecting a position of the drinking container 14, especially of a rim 18 of the drinking container 14 relative to at least one part of the beverage dispenser 1. The drinking container detection system 35 can be arranged for during use detecting the position of the drinking container 14 relative to said outlet end 15 of the spout 12. Such embodiments are for example shown in FIGS. 6-10C and can be combined with any of the features of the embodiments of FIGS. 1A-5B.

FIG. 6A en 6B show, in a view similar to that of for example FIGS. 2 and 3, a positioning provision CP in an alternative embodiment, provided with valve actuation system 35. In this embodiment the second positioning element 33 is movable relative to the first positioning element 27, when a rim 18 is pushed against the second positioning element 33. The second positioning element 33 is designed for engaging the valve 22, for opening said valve 22 when the second positioning element is pushed upward, as shown in the comparison between FIGS. 6A and 6B. In FIG. 6A the drinking container 14 is positioned with the rim 18 against the second positioning element 33 but not yet to against the first positioning element 27. The spout 12 can already enter into the drinking container 14. The second positioning element 33, especially an actuator 37 connected thereto by way of example, is not yet engaged with the valve 22. When pushing the drinking container further upward, as shown by the arrow 38 in FIG. 6B, the rim 18 is pushed up against the first positioning element 27, especially against the surface 28 thereof, whereas the second positioning element is pushed into engagement with the valve 22, such that the valve 22 is opened and beverage 13 is dispensed, indicated by arrow 16. Preferably the valve 22 will remain open after said actuation during dispensing of the beverage 13, even after bringing the drinking container 14 back into a more upright position, for example near the end of a dispensing cycle of a single a serving of beverage into the drinking container 14.

Alternatively the first and second positioning element can be movable relative to the dispenser housing 2 for actuating the valve, or the first positioning element 27 is movable relative to the second positioning element 33 is for actuating the valve 22.

In embodiments the valve 22 can be operated electrically, wherein movement of the or at least one of the positioning element(s) 27, 33 can actuate a switch for operating the valve 22, for example through the control unit 24.

FIGS. 7A and B show a relevant part of a further embodiment of valve actuating system 35, similar to that of for example FIG. 2 or FIGS. 6A and B, but in which the spout 12 is part of the valve actuating system 35, or at least is provided with an actuator 39 for the purpose of actuating the valve 22. In FIG. 7A a single, first positioning element 27 is disclosed, with a guide surface 29 and a n engagement surface 28. Alongside the spout 12 an actuator 39 is provide, for example a rod, which is movable alongside the spout 12 in an axial direction parallel to the axis A-A of the spout 12. In FIG. 7A the actuator is shown in an extended position, with a lowermost end 40 extending well beyond the outlet end 15 of the spout 12. A drinking container 14 is shown, extending over the spout 12 and actuator 39, with the rim 18 somewhat spaced apart from the engaging surface 28 and the inner wall part 31 of the drinking vessel 14 spaced apart from the end 40 of the actuator 39. The valve 22 is still closed in this position.

By pushing the drinking container 14 further upward from the position in FIG. 7A the rim 18 will be pushed against the engaging surface 28, as shown in FIG. 7B, in which also the end 40 engages the inner surface part 31 of the drinking container 14, such that the actuator is pushed upward alongside the spout 12, such that it actuates the valve 22, directly (as shown in FIG. 7B) or indirectly, for example by operating a switch as discussed. In this embodiment the spout 12 can be part of the valve actuation system 35.

FIG. 8A-C show schematically a dispensing system with a cartridge 8 suitable for use in a beverage dispenser according to the disclosure, for containing at least one beverage ingredient 9. In this embodiment the cartridge 8 comprises a housing 41, for example made using plastic and/or aluminum, as known in the art. The cartridge 8 comprises an outlet 42, for example at a lower side, into and/or through which an upper end 43 of a spout 12 extends. The upper end 43 is closed axially, but is provided with one or more side inlet(s) 44. The upper end 43 and a peripheral wall portion 45 of the outlet 42 together form a valve 22A which is closed in the position as shown in FIG. 8A and open on a position as shown in FIG. 8C, as will be explained. This forms an actuation system or at least part thereof wherein upon exerting pressure on the spout or a part thereof with a drinking container, especially with an inside wall part of such drinking container, the said valve is opened, as will be discussed by way of example with reference to FIG. 8.

In FIG. 8A the cartridge 8 has been introduced into a cartridge chamber 7, which is provided directly above a position where the drinking container 14 is to be held for dispensing beverage 13, and is only shown partly in FIG. 8. The spout 12 extends through an opening 46 in a wall 47 of the chamber 7, such that a drinking container 14 can be positioned below and/or over the spout 12. The valve 22A is closed in this position. A cam 49 of a dispensing mechanism is positioned schematically above the cartridge 8, which is supported eccentrically on an axis 50. A lever 51 extends from the cam 49 for rotating the cam 49.

In FIG. 8B the inner surface area 31 of the drinking container 14 is pushed against the spout 12, such that the spout 12 with the cartridge housing 41 is pushed upward, against the cam 49, with the valve 22A still closed. This can for example be accomplished by friction between the spout 12 and the wall 45. The housing of the cartridge is pierced in order to connect the line or conduit 19 with the interior of the cartridge 8. It will be clear that this can be achieved in any suitable way, for example using a piercing needle or by providing a different connecting mechanism for connecting the line or conduit 19 with the interior of the cartridge 8, for example a valve. The system is now ready for dispensing a beverage 13, with the drinking container 14 held in a proper position against the positioning elements 27, 33.

In FIG. 8C the system part is shown while dispensing beverage 13 into the drinking container 14, as indicated by the arrow 16. The cartridge housing 41 has been pushed down by the cam 49 rotated around the axis 50, whereas the spout 12 is held in position by the drinking container 14 pushed against the positioning elements 27, 33. Thus the valve 22A has been opened, for allowing a base liquid 5 to pass through the cartridge 8, mixing with the beverage ingredient 9 for forming the beverage 13 which is then dispensed through the spout 12 into the drinking container 14, flowing against the inner surface area 31. It will be clear that the beverage may be mixed in the cartridge and/or in the drinking container, whereas if multiple base liquids and/or multiple beverage ingredients are used for forming the beverage 13, part of the mixing can already be provided for before the liquid enters into the cartridge 8 as shown in FIG. 8.

The spout and/or the cartridge 8 may be provided with a provision 52, here shown as a rod on the spout 12, for limiting the movement of the spout 12 into the cartridge 8. This can have the advantage that the openings 44 will allow substantially all of the beverage eq liquid to drain from the cartridge 8 through the spout 12. Such provision 52 can also be provided for in a different manner, for example by providing a flange on the outside of the spout 12, abutting the wall 45 after a predetermined relative movement of the spout into the housing 41. In embodiments the provision 52 can be flexible, such that the spout can accommodate for different shapes and sizes of drinking containers 14, or such provision can be omitted.

As discussed, the dispenser 1 according to the disclosure can, at least during use, comprise a chamber 53 for mixing the at least one fluid, especially at least one base liquid 5 and optionally also a gas such as CO2 and/or N₂, with the at least one beverage ingredient 9 and/or for receiving beverage mixed from said at least one fluid and said at least one beverage ingredient, prior to dispensing of the beverage. The said chamber 53 can be an integral part of the dispenser 1 or can for example be exchangeable and/or disposable, for example as part of a cartridge 8. An example thereof is shown in FIGS. 9A-C.

FIG. 9A shows schematically part of a cartridge chamber 7, which, similar to that of FIG. 8, comprises a wall 47 with an opening 46 through which a spout 12 can extend during use. In this embodiment the spout 12 is again part of the cartridge 8, but it can also be a separate part or be part of the dispenser 1. The cartridge 8 again comprises a housing 41 to which the spout 12 is connected or is an integral part thereof. The housing 41 in this embodiment comprises a first part 41A and a second part 41B. The first part 41A is for example relatively rigid, compared to the second part 41B, and can for example be similar to the cartridge according to FIG. 8. The second part. 41B is in this embodiment more flexible than the first part 41A and is connected thereto, or made integral therewith. The second part 41B is designed to be expandable. In the embodiment of FIG. 8 this has been shown as a harmonica type of wall part 54, which can expand by stretching the harmonica type wall part 54, as will be explained. A connector element 55, such as for example a piercing element is provided in the chamber 7 for connecting a line or conduit 19 to the cartridge, for supplying at least one base liquid, similar to FIG. 8. The cartridge 8 can comprise a valve 22, for example in the spout 12, which can be activated, for example by the dispenser 1, for dispensing a beverage 13.

In this embodiment the first part 41A of the cartridge 8 has an internal volume V₁ comprising the beverage ingredient 9, such as for example a liquid or a powder, granules or the like. The second part 41B has, in the collapsed state as shown in FIGS. 9A and 9B, an internal volume V₂, which is preferably far smaller than the volume V1 of the first part 41A, for example close to zero.

As can be seen in FIG. 9B the cartridge 8 can be inserted into the chamber 7, with the spout extending through the opening 46. The cartridge chamber 7 has an internal volume V₃ which is significantly larger than the cartridge 8 with the second part 41B collapsed. As can be seen in FIGS. 9B and C in this embodiment the first part 41A fits in a lower part of the chamber 7.

Prior to dispensing a volume of base liquid 5 is inserted into the cartridge via line or conduit 19, expanding the cartridge 8, especially the second part 41B thereof, and mixing the beverage ingredient 9 with the base liquid 5. The volume of base liquid 5 with the beverage ingredient 9 can be the same as necessary for a single serving of beverage 13. Thus the internal volume of the cartridge 8 in the expanded state, as shown in FIG. 9C, provides for a chamber 53, which is in this embodiment a mixing chamber. When dispensing the beverage 13 the single serving can be dispensed in one go, for example by gravity or by pressurizing the cartridge by external pressure, compressing the cartridge back towards the original volume, or a smaller volume, for example by pressing the second part 41B into the first part 41A. The internal volume V4 of the cartridge in the expanded state as shown in FIG. 9C can correspond substantially to the internal volume V3 of the chamber 7.

FIG. 10a shows schematically part of a cartridge chamber 7, which is similar to that of FIG. 9A. In this embodiment, another embodiment of a cartridge 8 is depicted. The cartridge 8 comprises at least one positioning element 27 for positioning a rim 28 of a drinking container 14 relative to the cartridge 8, and in particular relative to an outlet end 16 of the spout 12. The at least one positioning element 27 may be formed by part of the spout 12, or may be a separate element which may be positioned adjacent to or near the spout 12.

In use, as for example shown in FIG. 10B, the positioning element 27 may extend out the opening 46 of the cartridge chamber 7, or conceivably a separate opening for the positioning element 27 may be provided, for example adjacent to or near the opening 46 for the spout. As such, at least part of the positioning element 27, such as a part of the positioning element 27 providing a first contact surface 28, may be exposed such that a user may position the glass 14 against the positioning element 27. When the glass 14 is positioned against the positioning element 27, a position of a part of the glass is determined relative to the cartridge 8, and in particular relative to an outlet end 16 of the spout 12, as depicted in FIG. 10C.

When the cartridge 8 comprises the positioning element 27, different positioning elements 27 may be used for different cartridges 8, and thus for different types of beverage. As such, for example when a beverage is more prone to foaming, the positioning element 27 may be shaped and positioned relative to the cartridge 8 such that excessive foaming may be prevented. When a beverage is less prone to foaming, the positioning element 27 may be shaped and positioned relative to the cartridge 8 such that insufficient foaming may be prevented. It will be understood that the positioning element 27 comprised by the cartridge may have any shape and/or functionality disclosed in conjunction with positioning elements disclosed in conjunction with the dispenser 1. Conceivably, in embodiments, also the second positioning element 33 may be comprised or formed by the cartridge 8. As such, also a tilting angle of the drinking container 14 may be adjusted per cartridge, and hence per specific beverage.

It shall be clear that an expandable cartridge 8 can also be provided in different ways, for example as a pouch which is folded or collapsed initially, only containing the beverage ingredient, or stretchable, such that the wall of the cartridge is at least partly stretched when the base liquid is inserted into the cartridge 8. In embodiments the entire cartridge can be expandable. In embodiments the chamber 53 can have a volume larger than a single serving, for example multiple servings.

In embodiments a cartridge 8 can comprise a filter (not shown) for filtering out particles, such as but not limited to proteins formed in the beverage ingredient 9. Preferably such filter is provided such that the beverage ingredient is forced through the filter prior to being discharged into the base liquid 5.

In embodiments the first positioning element 27 has a first contact surface 28 and the second positioning element 33 has a second contact surface 34, which first contact surface 28 and second contact surface 34 are in a plane inclined relative to a horizontal plane H, such that a drinking container 14 has to be tilted in order to be pushed against both the first and second contact surface 28, 34 simultaneously.

In a method according to the disclosure a beverage is supplied from a beverage source or formed from at least a fluid and at least one beverage component, and the beverage is dispensed from a dispenser, wherein an open end, especially a rim 18, of a drinking container 14 is held against at least one positioning element 27 of the dispenser 1. The positioning element 27 or elements 27, 33 define a position of the drinking container 14 relative to a dispensing spout 12 of the dispenser 1.

In such method the at least one positioning element 27, 33 can be part of a drinking container detection system, wherein if the drinking container 14 is detected by the drinking container detection system of the dispenser 1, especially when the said defined position of the drinking container 14 is detected, beverage is or can be dispensed.

In a method according to the disclosure, wherein there are at least a first positioning element 27 and a second positioning element 33, the drinking container 14 is pushed against the said first positioning surface 28 and against said second positioning surface 34, such that a valve actuation mechanism of the beverage dispenser 1 is activated and beverage 13 is dispensed into said drinking container 14. In such method according to the disclosure said beverage 13 is preferably dispensed when one of said first positioning surface 28 and said second positioning surface 34 is moved relative to the other of the first and second positioning surface 34, 28 by the drinking container 14 pushed against them and/or the first positioning surface 28 and second positioning surface 34 are moved relative to the dispenser 1 by the drinking container 14 pushed against them.

In an alternative method according to the disclosure the dispenser 1 comprises at least a detector for detecting an inner wall surface 31 of the drinking container 14, wherein when the said surface 31 of the drinking container 14 is pushed against the detector beverage is dispensed. This is for example shown in FIGS. 7A and 7B and FIGS. 8A-8C.

A cartridge 8 according to the disclosure preferably contains a beverage component 9 for use in a beverage dispenser 1, wherein the cartridge 8 preferably comprises at least an inlet for a fluid 5 for mixing with the beverage component 9 and a spout 12 for dispensing the beverage 13 formed from the fluid and the beverage component 9. The inlet can for example be an inlet formed by piercing a wall of the cartridge 8, or for example a valve, such as a one-way valve, a duck bill type of valve, or any other suitable inlet. The spout can be an integral part of the cartridge 8, or can be a separate part.

The cartridge 8 can comprises a chamber 53 for containing said beverage prior to dispensing, which chamber 53 can in embodiments be a mixing chamber. In embodiments the chamber 53 can be an expandable chamber. In embodiments the chamber 53 has or can be brought into position having an internal volume for holding a single serving of beverage.

The invention is by no means limited to the embodiments specifically shown and described here before. Many variants are possible thereof within the scope of the claims.

For example a dispenser according to the disclosure can comprise more than two positioning elements, for example three, evenly spaced around the periphery of the rim of a drinking container, or a single positioning element can be formed as a ring or such element, with the spout extending therethrough. The or each cartridge can be a disposable cartridge or can be a reusable cartridge. A dispenser according to the disclosure can comprise multiple cartridge chambers for receiving different cartridges, which may each comprise the same or different ingredients. Alternatively the or each cartridge chamber can be designed for receiving a beverage ingredient directly, without a containing cartridge, for example provided from an ingredient source external or internal to the dispenser. Valve actuators for dispensing beverage and/or for providing base liquid and/or gas can be mechanical actuators, such as for example a traditional tapping valve with a tapping handle, wherein the valve can be integral to the dispenser or can be a replaceable, especially disposable valve, or can be electronically operated, for example through the control unit. A valve can be a traditional valve or for example a squeeze valve. A dispenser according to the disclosure can be provided with cleaning provisions, as known in the art, for example for flushing chambers and conduits with a cleaning liquid. As discussed cooling means can be provided for cooling the or each or at least a base liquid, for cooling the or each or at least a beverage ingredient and/or for cooling the beverage (to be) dispensed. Additionally or alternatively to cooling means heating means can be provided. for heating base liquid, beverage ingredient and/or beverage.

These and many other variants are considered falling within the scope of the disclosure, including also any combination of features of the embodiments as disclosed.

1. A beverage dispenser, comprising a housing, wherein the dispenser:
is connected to or connectable to a beverage source and/or
comprises and/or is connectable to at least one fluid source and at least one source for a beverage ingredient, and comprises a mixing system for mixing into a beverage fluid from the at least one fluid source and the at least one beverage ingredient from the beverage ingredient source,
wherein the dispenser further comprises a dispensing system for dispensing the beverage, the dispensing system comprising at least a spout with an outlet end, wherein the beverage dispenser further comprises at least one positioning element for positioning a rim of a drinking container relative to the outlet end of the spout.

2. The beverage dispenser according to claim 1, wherein at least two positioning elements are provided, spaced apart from each other, for positioning the rim of the drinking container, by engaging the rim at at least two spaced apart positions.

3. The beverage dispenser according to claim 1, wherein the spout has a longitudinal axis, at least at the outlet end, and an axial dispensing direction along said longitudinal axis, wherein the or each positioning element is positioned such that when a rim engages said at least one positioning element, a plane defined by said rim is at an angle relative to said longitudinal axis of the spout, such that the dispensing direction is directed to an inner surface area of the drinking container adjacent the rim.

4. The beverage dispenser according to claim 1, further comprising at least one cartridge receiving space, for receiving a cartridge containing said at least one beverage ingredient.

5. The beverage dispenser according to claim 1, wherein the dispenser comprises at least a valve, and the dispensing system further comprises a valve actuation system for opening the at least one valve and dispensing the beverage into a drinking container, wherein the valve actuation system comprises a drinking container detection system comprising at least said at least one positioning element arranged for during use detecting a position of the drinking container relative to at least one part of the beverage dispenser.

6. The beverage dispenser according to claim 5, wherein the valve actuation system comprises at least a first and a second positioning element, spaced apart from each other, wherein at least:
one of the first and second positioning element is movable relative to the other of the first and second positioning element and/or
the first and second positioning element are movable relative to the housing, wherein only when:
said one of the first and second positioning element is moved relative to the other of the first and second positioning element and/or
the first and second positioning element are moved relative to said housing the at least one valve is opened for dispensing of said beverage.

7. The beverage dispenser according to claim 6, wherein the said first positioning element has a first contact surface and the second positioning element has a second contact surface, which first contact surface and second contact surface are in a plane inclined relative to a horizontal plane, such that a drinking container is tilted in order to be pushed against both the first and second contact surface simultaneously.

8. The beverage dispenser according to claim 1, wherein during use, the dispenser comprises a chamber for mixing the at least one fluid with the at least one beverage ingredient and/or for receiving beverage mixed from said at least one fluid and said at least one beverage ingredient, prior to dispensing of the beverage.

9. A method for dispensing a beverage into a drinking container, wherein a beverage is:
supplied from a beverage source; or
formed from at least a fluid and at least one beverage component,
and the beverage is dispensed from a dispenser, wherein an open end, especially a rim, of a drinking container is held against at least one positioning element of the dispenser, wherein the positioning element or elements define a position of the drinking container relative to a dispensing spout of the dispenser.

10. The method according to claim 9, wherein the at least one positioning element is part of a drinking container detection system, wherein if the drinking container is detected by the drinking container detection system of the dispenser, beverage is or can be dispensed.

11. The method according to claim 9, wherein there are at least a first positioning element and a second positioning element, wherein the first positioning element comprises at least a first positioning surface and the second positioning element comprises at least a second positioning surface, wherein when said drinking container is pushed against said first positioning surface and against said second positioning surface, a valve actuation mechanism of the beverage dispenser is activated and beverage is dispensed into said drinking container.

12. The method according to claim 11, wherein said beverage is dispensed when:
one of said first positioning surface and said second positioning surface is moved relative to the other of the first positioning surface and second positioning surface by the drinking container pushed against them; and/or
the first positioning surface and second positioning surface are moved relative to the dispenser by the drinking container pushed against them.

13. The method according to claim 9, wherein the dispenser comprises at least a detector for detecting an inner wall surface of the drinking container, wherein when the said surface of the drinking container is pushed against the detector, beverage is dispensed and/or wherein the dispenser comprises at least a detector for detecting an inner wall surface of the drinking container, wherein when the said detector is pushed against said surface of the drinking container, beverage is dispensed.

14. A cartridge containing a beverage component for use in a beverage dispenser, wherein the cartridge comprises at least an inlet for a fluid for mixing with the beverage component and a spout for dispensing the beverage formed from the fluid and the beverage component, wherein the cartridge further comprises a chamber for containing said beverage prior to dispensing.

15. The cartridge according to claim 14, wherein the cartridge comprises a positioning element for positioning a rim of a drinking container relative to the cartridge relative to an outlet end of a spout of the cartridge.

16. The beverage dispenser according to claim 3, wherein the or each positioning element is designed for extending over at least part of an opening of a drinking container defined by said rim.

17. The beverage dispenser according to claim 16, wherein the at least one positioning element:
has a substantially flat or stepped engaging surface for engaging the rim of said drinking container and/or
wherein the one positioning element or at least one of the positioning elements is provided with a guide element extending from said engaging surface for engaging an outer surface part of the drinking container, adjacent the rim.

18. The beverage dispenser according to claim 4, wherein the spout is part of the said at least one cartridge and/or wherein the at least one cartridge comprises a valve.

19. The beverage dispenser according to claim 5, wherein the spout is part of the valve actuation system and/or the spout comprises and/or is connected to an actuation mechanism, such that upon exerting pressure on the spout or a part thereof with a drinking container the said valve is opened

20. The beverage dispenser according to claim 19, wherein the drinking container detection system is arranged for during use detecting the position of the drinking container relative to said outlet end.

21. The beverage dispenser according to claim 8, wherein the mixing chamber has a volume substantially equal to or larger than the volume of the drinking container and/or wherein the mixing chamber is an expandable chamber and/or wherein the mixing chamber is part of at least one cartridge.

22. A cartridge according to claim 14, wherein the chamber is a mixing chamber and/or wherein the chamber has or can be brought into position having an internal volume for holding a single serving of beverage.

23. A cartridge according to claim 22, wherein the chamber is an expandable chamber.
